(19) United States
(12) Patent Application Publication
(10) Pub. No.: US 2004/0017390 A1
(43) Pub. Date: Jan. 29, 2004

(54) Self instructional authoring software tool for creation of a multi-media presentation

(76) Inventors: Ruth Helene Knowlton, Houston, TX (US); Diane Elizabeth Dieter Hughes, Houston, TX (US)

Correspondence Address: RUTH HELENE KNOWLTON, 9206 TISH COURT, HOUSTON, TX, 77040, US

(21) Appl. No.: 10/206,153

(22) Filed: Jul. 26, 2002

(51) Int. Cl. G09G 5/00; G06F 15/00

(52) U.S. Cl. 345/731; 345/719; 345/727; 715/500.1

(57) ABSTRACT

This invention is a multi-lingual self-training, interactive, multi-media authoring tool that uses computerized methods and systems to produce multi-media presentations which can be outputted in any combination and at the user's discretion can be e-mailed, posted to a website, printed or written onto external media such as a disk or CD. The invention may be referred to as an electronic scrapbook but is not limited to that functionality. The invention uses a graphical user interface and creates interactive dialogue between the user and the software. It uses the user's own selected media; specific types supported are defined by the user. Media assets can be selected from a file or captured in real-time during the presentations creation and written to a file. Presentation elements written to files are tagged with identifiers defined by the user. By using a keyword search feature, the user's family of presentations and/or a data bank of presentations can be searched against category criteria. All relevant presentations can then be compiled onto a single submission. A processor plays back the presentation and facilitates editing. The system then automatically generates the web code needed for the production of the composited presentation(s) including buttons and thusly it integrates all assets to produce an interactive multi-media presentation. The user can select various format styles of output and preview assets. The software can be run from a web-connected server or from any 233 mHz or better personal computer configured with appropriate peripheral equipment.

### FIELD OF THE INVENTION

This invention is related to the application of a self-instructional software system and its data files to produce an interactive multi-media presentation that can be published to a variety of output media.

### BACKGROUND OF THE INVENTION

It is common practice for individuals to create letters, which include photographs that, for the purposes of this patent, we will call Presentations. Historically, these presentations were prepared by hand or typewritten and then mailed. With the advent of the widespread use of computers, individual users can send emails with attachments but with out music or voice. Some Software has been developed to try and address the users needs. An example of this is Microsoft's Publisher software. The software allows the user to select a format and enter the information into a template. The viewer sees how the presentation will appear as they are entering the information. These systems are typically limited to text-based printed presentations. The printed presentations can be attached to an email but they are still just electronic images of the printed presentation and are not interactive.

Now, commercial Internet services such as presentation.com and 10minutepresentation.com now enable an individual to create a presentation on-line, print the presentation and/or email it. The site 10minutepresentation.com helps the user to post their finished presentation to a web site. However, these are still text-based presentations, containing no sound, video or other new media, and they are not interactive, nor do they interact with any of the user's other media software or computer hardware.

Due to the recent occurrences in the United States and around the world, users are less likely to travel, making it difficult and time consuming to attend family functions. Therefore, with so many important events happening in the users life, a need has arisen to allow the user to convey information in the form of presentations. The inclusion of media in these presentations can be an asset, which differentiates them from the ways of the past. For example, video clips of family member's significant events can be included into an electronic holiday letter with this invention.

### SUMMARY OF THE INVENTION

The objective of this invention is to help users with limited computer skills and no training in multi-media production to convey information to a specific audience of recipients by allowing them to create presentations through the use of media, such as narration, pictures, animation, video clips and other portfolio pieces. The inventors recognize that an individual may want to customize their presentations according to the specific topic (such as family history) and/or a specific group. Therefore, in addition to supporting an unlimited number of groups, this invention supports multiple kinds of presentations. Each version of the presentation is identified by a title supplied by the user and is accessible by that user.

The inclusion of the media is done in such a manner as to link the media to a particular item within the presentation. For example, an individual may choose to use a 10 second video close-up as an introductory piece in place of the traditional opening letter. The owner of a business might want to use a Flash animation to help explain a new process that a management or technical candidate developed. These individuals may choose narrations at the beginning of one presentation and in the next presentation, may decide to have a musical opening. In either case, the media is not extraneous, but provides an improved presentation, showing both tangible results such as accomplishments achieved and the user's personality, which can be critical in conveying their message in the presentation.

This invention is” user friendly”. It has a narrator that provides instructions to the individual user through each step of the media creation process through its graphic user interface feature. This feature raises the comfort level of an individual who has never used a computer before. It allows the novice to produce a dynamic media creation that is then outputted in the format and to the medium they select. They do not need any prior knowledge of any kind about the Internet. In this invention, the software interface allows the individual to perform such specific media functions as to play audio clips, play video clips, operate a scanner, burn a CD, write to a disk, import media files as well as text files, and convert file formats, in step by step narrator directed instructions. The individual can also dynamically link to other media software packages that reside on the main system. All of this is controlled by the multi-media interface component of this invention, which facilitates the user being able to, at run time, dynamically capture media for inclusion into the presentation; said media being sounds, pictures, video clips, text-based presentations; said media being captured by an application specified by the user; said media being captured by the specified software application while under the direction of a graphical user interface and instructions supplied by this system; said interface being of such as self-explanatory nature and detail that the user need have no prior experience using the application under control of this system to achieve success at capturing the media. The invention allows the output to be viewed inside a web browser prior to acceptance for publication to an output media and supports the user's selection of output media; said output formats being upload to a web site, output to a mass storage device such as CD, floppy or high storage media such as Zip or Jazz, an attachment to an email, printed copy, or copy to another location on a hard drive. The invention can also automatically compress file formats to support the creation of the presentation with the desired output format; said processor giving an error message to the user if the file sizes cannot be compressed to a suitable size for transmission or viewing; said processor looking at space available on the output media or appropriate for transmission, and the file size of the integrated presentation. The individual also have a choice of output style and “look and feel”. The invention provides the individual multiple formats in which to choose from. These multiple outputs have text, photos and/or videos in different spaces on the page thusly allowing for the individual to express their own person preference as to the” look and feel” that they want to project to whom ever they choose. For example if an individual graduated, they would want to present the output of their presentation differently than if they went on a vacation

The invention allows the individual to store their presentations after they have sent it to whomever they desired, retrieve it in the future as a reference or review it. This benefit within the invention is important because most individuals send some sort of information on a yearly basis. So since the presentations can be updated through the editing process, individuals can come back in two hours, two weeks, two months, two years or anytime and revamp and/or revise their presentation.

The user doesn't require the knowledge of any computer language such as HTML because the invention generates the code for the individual users media presentation to the desired destination that the individual desires. The invention also contains its own library of buttons and other navigational elements needed to display the presentation output in the selected format, with the appropriate functionality for the media types; said functionality being specific media players, such as but not limited to Real, Microsoft, QuickTime and Macromedia players; said players being automatically included according to media type and selected display format and output media.

Additionally, the media is tagged with descriptors so that searches can be conducted through the use of media libraries. These tags include media type, title, keywords or phrases, user-supplied descriptions, and descriptors set or identified by the media processor such as file size, image height and width, movie run time and dates of creation or modification, and cross reference information such as where and how the media has been used. For example, a narration might be used in the introductory portion of the user's first presentation, and then later reused in another section of the user's presentation. The individual has the ability to store media and arrange it at will to accommodate whichever type of presentation that is needed or desired.

### OBJECTS AND ADVANTAGES OF THE INVENTION

The use of this invention gives the user the ability to be creative by presenting their positive intangible qualities such as personality and enthusiasm to be communicated to whomever they send it to. This invention helps the user to differentiate their presentation from that of others.

Hard copy scrapbooks cannot be easily or economically distributed to others; the electronic scrapbooks are reproducible very economically. In addition to pictures and artistic embellishments found in hard copy scrapbooks, the electronic scrapbook can contain background music, personalized narration and video clips.

Travel costs users a lot of money. By using the outcome of this invention, users are better able to convey their desired messages through their presentations without leaving their homes.

Managing the presentations through the use of tags enables this presentation system to link and communicate with other systems.

### BRIEF DESCRIPTION OF THE DRAWINGS

The accompanying drawings, which are incorporated in and form part of the specification, illustrate an embodiment of the present invention and, together with the description, serve to better explain the operational features, and advantages of the invention. It should be understood, however, that the invention is not limited to the precise arrangements and instrumentalities shown.

FIG. 1 illustrates a typical system architecture for the system of processors and data;

FIG. 2 is a block diagram illustrating the elements of the media management processor;

FIG. 3 illustrates the architecture for the output generation processor;

FIG. 4 is a block diagram illustrating the architecture of the primary user interface for the presentation generator processor;

FIG. 5 illustrates the invention, a self-instructional authoring software tool for the creation of multi-media presentations.

### DETAILED DESCRIPTION OF THE INVENTION

Self Instructional Authoring Software Tool for the Creation of a Multimedia Presentation

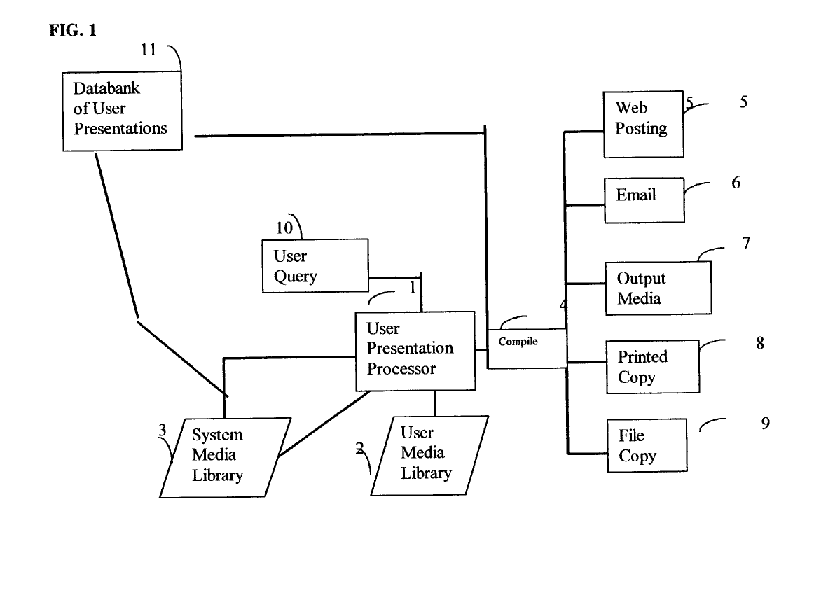

Prior to discussing the multimedia presentation design, we need to get a general overview of the system. FIG. 1 illustrates the typical system architecture for the system of processors and data. As you can see in this figure, there are eleven specific components, which comprise the processor and data. 1, user Presentation Processor allows the individual user to create a presentation which contains visuals and sound. 2, user media library allows the user the opportunity to store data in various forms, i.e. pictures, videos, narrations and music and then these said items can be reused over and over in various Presentations and formats. This library set is solely for the individual user and may not be accessed by other users. 3, system media library contains generic information that can be obtained and used by different users. 4, compile allows the user to pull all aspects of the Presentation together and then decide which output format to use. 5, web posting is just one of five ways that a user can select which permits them to export their Presentation. The web posting allows them to choose a URL and then place it on that site. 6, Email is the second output function, which allows the user to send the Email to various addresses, which are not exclusive to prospective employers but can go anywhere. 7, output media covers various external removable, transportable ways to export your Presentation. They include: Zip disks, 3½ inch Floppy disks, Jazz and CD as well as any new technology which allows one to export media and carry it off.

8, printed copy lets the user print out the Presentation in the normal sense with graphics in tact in the format that they select. 9, file copy permits the user to put the Presentation to a file where it can be retrieved and exported and/or edited at a later date. 10, user query allows the user to put in a keyword to access a presentation. 11, databank of user presentations stores an unlimited number of presentations to be stored and then later retrieved by the user.

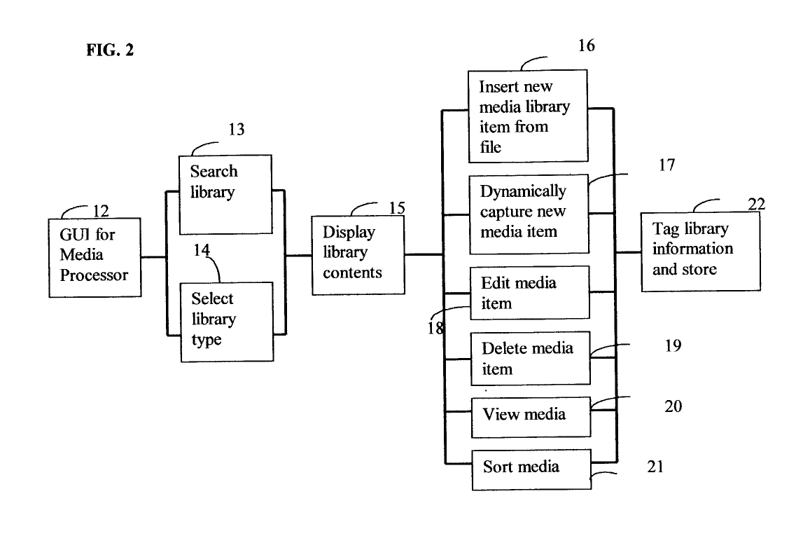

In FIG. 2, the invention deals with a block diagram illustrating the elements of the media management processor. 12, GULI for media processor is a graphical user interface, which allows the user to go through the system by way of visuals and verbal prompting. 13, search library is a feature that displays the various media categories that can be accessed by the user. They include: photos, sound, video, text, flash, real media and pdfs. 14, select library type now allows the user to go into the above stated media categories in order to update, delete or add to the selected category. 15, display library contents let the user view the items that are in the selected category. 16, insert new media library item from file gives the user the opportunity to go into the computer system and import the media from a file. The file can be on the computer system, a CD, a Zip, a 3½-inch Floppy or Jazz. 17, permits the user to dynamically capture a new media item, to scan in media, record their voice and/or capture video, all with no prior experience. 18, edit media item gives the user the freedom to edit or change any item that they select and it walks them through each step with narrative instructions. 19, delete media item lets the user pick and choose which items stay and which go. 20, view media is a feature where the user can view the media selections they have under that presentations title. 21, sort organizes the media by fields either by name or category.

22, tag library information and store by the following methods: file size, dates, height, width, duration, title, subject, description, author and/or keywords.

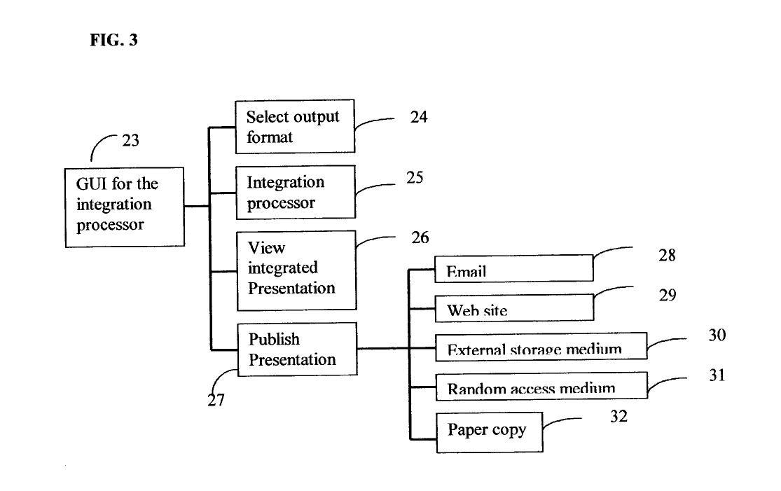

FIG. 3 illustrates the architecture for the output generation processor. 23 GUI for the integration processor is a graphical user interface that allows the user to go through the system. They are prompted by easily understandable visual queues and verbal prompts. 24, select output format permits the users to select the format that they want to use in the output of their final presentation. 25, integration processor compiles all the user information into a viewable format. 26, view integrated presentation gives the user the opportunity to view the compiled presentation to make sure it looks the way they want it to before it is published. 27, publish presentation allows the user the freedom to choose which avenue of output they desire for their presentation. 28, Email as mentioned in FIG. 1 is one way that a presentation can be published. 29, website is a location where a users presentation can be published. 30, external storage medium allows the user to publish their presentation to a Zip, CD disk, 3½ inch Floppy or Jazz. 31, random access medium allows the user to publish their presentation to the computer systems hard drive or to a Local Area Network server or a Wide Area Network server. 32, paper copy can also be generated and published by the user if that is what they desire.

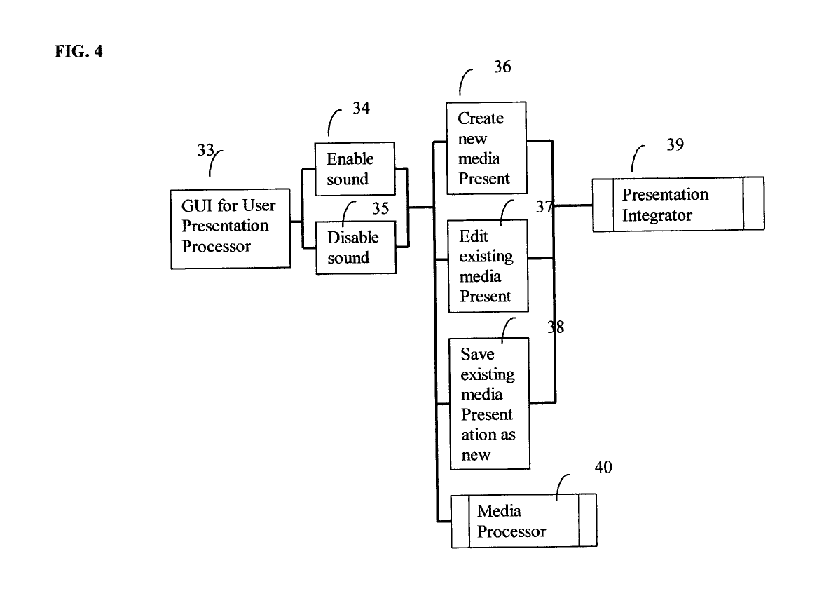

FIG. 4 is a block diagram illustrating the architecture of the primary user interface for the presentation generator processor. 33, GUI for user presentation processor takes the user from screen to screen in the invention with easily understandable visual and verbal instructions. 34, enable sound is a function within the system, which allows the user to use a narrator who verbally leads them through each step of the presentation creation process. 35, disable sound is a feature in the system that allows a user to go through the system without any assistance, 36, create new media presentation enables the user to build a new presentation. 37, edit existing media presentation is a feature which lets the user change or edit a previous presentation to update it or change it in any way that they choose. 38, save existing media presentation with a new name allows the user to change the way a presentation is saved for retrieving at another time. 39, presentation integrator is a subroutine or stand-alone program which can be called as apart of the invention to integrate the presentation components. 40, media processor is also a stand-alone program which allows the invention to manage the media.

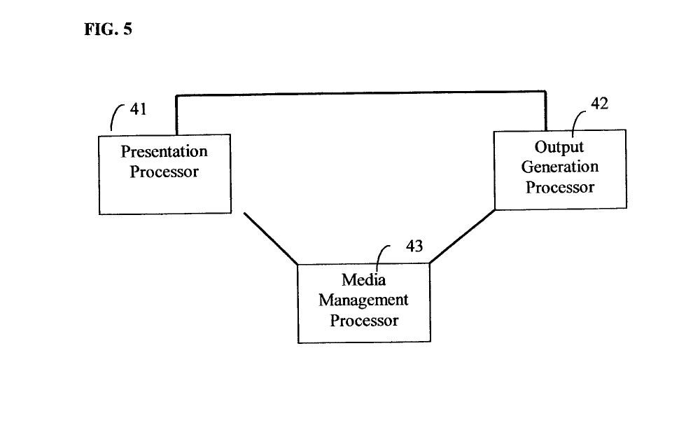

FIG. 5 illustrates the invention, as a self-instructional authoring software tool for the creation of a multi-media presentation. 41, presentation processor gives a user the ability to create a dynamic, media enhanced presentation. 42, output generation processor gives the user the freedom to output their presentations for submission in various outputs (see FIG. 1). 43,shows the media management processor.

We claim:

1. A computerized software system which is used to produce electronic presentations which contain audio and/or visual media elements to illustrate the text items; said software being authored with a multi-media tool, having interactive self-training features for the end user so that he/she may use the system without the need for any formal training; said software containing libraries of audio and visual media used to embellish, scrapbook-style, the material essence of the presentation; said software using and generating data files and elements for presentations, lining and including a full spectrum of audio and visual media; said software generating its own code for a compressed format output, capable of being posted to a web site, burned to a CD or delivered by email; said software linking to other software on the user's computer for the purpose of integrating the functions within the primary program; said software system supplying the style templates for the end user to select the style of output presentation and mode(s) of delivery.

2. A system according to claim 1, which can reside on a stand-alone computer.

3. A processor according to claim 1, which controls the operation of other media software and peripheral hardware through an instructional graphical user interface, having audio directed interactions; said software to perform such specific media functions as to create and/or play audio clips, play or capture video clips, operate a scanner, burn a CD, write to a disk, import media files as well as text files, and convert file formats, as needed; said controls and definitions being supplied by the user at time of set-up based on queries from the processor to the user.

4. A processor according to claim 3, that allows the user to dynamically link to other media software packages residing on their system, under the control of a multimedia interface, and storing the results in data files for later use by the system.

5. A processor according to claim 3, which enables the user to add to the media library, delete from the library, or make edits to the contents of the media library, and otherwise manage the content of the media library with tags, keywords and descriptors.

6. A processor according to claim 3, which facilitates the user being able to, at run time, dynamically capture media for inclusion into the presentation; said media being sounds, pictures, video clips, text-based presentations; said media being captured by an application specified by the user; said media being captured by the specified software application while under the direction of a graphical user interface and instructions supplied by this system; said interface being of such a self-explanatory nature and detail that the user need have no prior experience using the application under control of this system to achieve success at capturing the media.

7. A processor according to claim 1, which tags the data files and elements with information to enable searches; said searches being able to locate media files of a certain type, size or content; said searches being able to identify a presentation of a certain title or content; said searches being able to identify matches between the databank of presentations and specific category criteria.

8. A processor according to claim 1, which allows the format of a presentation to be selected by the end user from a collection of templates.

9. A processor according to claim 1, which allows the user to select theme libraries of media content, and interactively “dragged” onto the presentation screen and placed on the presentation artistically to enhance the presentation of the primary content; said media elements re-usable; said media elements being selected by library group by the user as needed.

10. A processor according to claim 1, which integrates all selected information, text, and media assets, and automatically generates generic web-enabled program code to display that selected information, text and media assets according to the chosen format.

11. A processor according to claim 10, which contains its own library of buttons and other navigational elements needed to display the presentation output in the selected format, with the appropriate functionality for the media types; said players being automatically included according to media type and selected display format and output media.

12. A processor according to claim 10, which allows the output to be viewed inside a web browser prior to acceptance for publication to an output media.

13. A processor according to claim 1, which supports the user's selection of output media; said output formats being uploaded to a web site, outputted to a mass storage device such as CD, floppy or high storage media such as Zip or Jazz, an attachment to an email, printed copy, or copy to another location on a hard drive.

14. A processor according to claim 1, which can automatically compress file formats to support the creation of the presentation with the desired output format; said processor giving an error message to the user if the file sizes cannot be compressed to a suitable size for transmission or viewing; said processor looking at space available on the output media or appropriate for transmission, and the file size of the integrated presentation.

15. A system according to claim 1, which can support the users having the capability to have multiple presentations within their files; said users being able to access media in their own private media library.
